(19) United States
(12) Patent Application Publication
(10) Pub. No.: US 2006/0075047 A1
(43) Pub. Date: Apr. 6, 2006

(54) Electronic file delivery device and delivery method

(76) Inventor: Kentarou Fujii, Fukuoka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/998,839

(22) Filed: Nov. 30, 2004

(30) Foreign Application Priority Data
Sep. 21, 2004 (JP) P2004-273843

(51) Int. Cl. G06F 15/16

(52) U.S. Cl. 709/206

(57) ABSTRACT

In delivering various types of electronic files to a recipient specified by a sender, even after the operation of transmission is done, the transmission can be confirmed again before the electronic file is received by the recipient so as to securely cancel the delivery if necessary. When a delivery device acquires an electronic file from a sender, electronic mail for notification of electronic file deposit is transmitted to a recipient by an electronic mail transmission means. The recipient is then made to make a request for the reception of the electronic file to the sender through a means for providing a Web page for requesting electronic file reception. Electronic mail for requesting electronic file reception is transmitted to the sender by an electronic mail transmission means for requesting electronic file reception. Only when the reception of the electronic file is permitted, the electronic file is transmitted to the recipient by an electronic file transmission means.

### BACKGROUND OF THE INVENTION

1. Field of the Invention

The present invention relates to an electronic file delivery device and an electronic file delivery method for delivering various types of electronic files to a recipient specified by a sender.

2. Description of the Related Art

As a system for delivering various types of electronic files to a recipient specified by a sender, for example, an electronic mail system using a protocol such as SMTP (Simple Mail Transfer Protocol), POP (Post Office Protocol), and IMAP (Internet Message Access Protocol) are known. Also known are electronic file delivery systems suitable for delivering a large-volume file. These are described in Unexamined Japanese Patent Publication No. 2002-269012 and the non-patent document, the online Web page “Registered Mails on the Internet, Naviexpress” by NTT NaviSpace Corporation (searched on Sep. 14, 2004) [URL: http://www.naviexp.com/service_ne.html].

FIG. 10 is a conceptual view of a conventional electronic file delivery system as described above.

As shown in FIG. 10, in the conventional electronic file delivery system, when a sender A uploads an electronic file 51 on a server 50, the uploaded electronic file 51 is stored on the server 50. Then, electronic mail 52 to notify a recipient B of the arrival of the electronic file 51 is transmitted from the server 50 to the recipient B. The recipient B connects to the server 50 based on a notification for password authentication to receive the electronic file 51 from the server 50.

In the conventional electronic mail systems mentioned above, various types of electronic files are transmitted as files attached to electronic mail. Since anybody with the user ID and the password of the authentic recipient can easily surreptitiously read the electronic mail even when they are not the authentic recipients, this system has a low level of confidentiality. Moreover, once electronic mail is transmitted, the delivery of the electronic mail cannot be cancelled due to its transmission and reception mechanism. Therefore, if electronic mail is transmitted to an unintended recipient, there is no means to retrieve it.

On the other hand, in the above-mentioned conventional electronic file delivery system, security is enhanced by authenticating a recipient with a password. However, once electronic mail notifying a recipient of the arrival of an electronic file is transmitted to the recipient, the recipient is free to authenticate themselves with a password so as to obtain the electronic file. Therefore, for the same reasons as described above, it is difficult to cancel the delivery of the electronic file once transmitted.

In the electronic file delivery system described in the above non-patent document, it is possible to cancel the delivery of the electronic file once transmitted. However, if sufficient time has elapsed after the transmission so that an electronic file has already been delivered to a recipient, or if a recipient has already authenticated themselves with a password earlier so as to obtain the electronic file, it is too late to cancel the delivery. In particular, when an electronic file is transmitted although the sender does not intend to do it, there is a possibility that the electronic file may be delivered to the recipient before the sender realizes it.

### SUMMARY OF THE INVENTION

In view of the problems in the conventional technologies, an object of the present invention is to provide an electronic file delivery device and an electronic file delivery method, when a sender delivers various types of electronic files to a recipient specified by the sender, which allow the sender to confirm again transmission of the electronic files before the recipient receives the electronic files so as to ensure cancellation of the delivery if required even after the operation of transmission is already done.

An electronic file delivery device of the present invention includes: means for providing a Web page for electronic file transmission for acquiring, from a sender terminal used by a sender transmitting an electronic file, the electronic file, sender information by which the sender can be identified, an electronic mail address of the sender, and an electronic mail address of a recipient receiving the electronic file; storage means for storing the electronic file acquired through the Web page for electronic file transmission; means for providing a Web page for requesting electronic file reception for acquiring, from a recipient terminal used by the recipient receiving the electronic file, recipient information by which the recipient can be identified to make a request for permission to receive the electronic file to the sender; means for transmitting electronic mail for notification of electronic file deposit to the electronic mail address of the recipient acquired through the Web page for electronic file transmission, the electronic mail for notification of electronic file deposit containing the sender information acquired through the Web page for electronic file transmission and link information to the Web page for requesting electronic file reception; means for transmitting electronic mail for requesting electronic file reception to the electronic mail address of the sender acquired through the Web page for electronic file transmission, the electronic mail for requesting electronic file reception containing the recipient information acquired through the Web page for requesting electronic file reception and link information for permitting or not permitting the recipient to receive the electronic file; means for transmitting electronic mail for electronic file delivery containing link information for acquiring the electronic file stored in the storage means to the electronic mail address of the recipient acquired through the Web page for electronic file transmission if the reception of the electronic file is permitted based on the link information contained in the electronic mail for requesting electronic file reception, while transmitting electronic mail indicating non-permission for the reception of the electronic file to the electronic mail address of the recipient if the reception of the electronic file is not permitted based on the link information contained in the electronic mail for requesting electronic file reception; and means for transmitting the electronic file to the recipient terminal connected based on the link information contained in the electronic mail for electronic file delivery.

An electronic file delivery method of the present invention includes the steps of: providing a Web page for electronic file transmission for acquiring, from a sender terminal used by a sender transmitting an electronic file, the electronic file, sender information by which the sender can be identified, an electronic mail address of the sender, and an electronic mail address of a recipient receiving the electronic file; storing the electronic file acquired through the Web page for electronic file transmission in storage means; transmitting electronic mail for notification of electronic mail deposit to the electronic mail address of the recipient acquired through the Web page for electronic file transmission, the electronic mail for notification of electronic mail deposit containing the sender information acquired through the Web page for electronic file transmission and link information to a Web page for requesting electronic file reception for acquiring recipient information by which the recipient can be identified to make a request for permission to receive the electronic file to the sender from a recipient terminal used by the recipient receiving the electronic file; providing the Web page for requesting electronic file reception to the recipient terminal connected based on the link information contained in the electronic mail for notification of electronic file deposit; transmitting electronic mail for requesting electronic file reception to the electronic mail address of the sender acquired through the Web page for electronic file transmission, the electronic mail for requesting electronic file reception containing the recipient information acquired through the Web page for requesting electronic file reception and link information for permitting or not permitting the recipient to receive the electronic file; transmitting electronic mail for electronic file delivery containing link information for acquiring the electronic file stored in the storage means to the electronic mail address of the recipient acquired through the Web page for electronic file transmission if the reception of the electronic file is permitted based on the link information contained in the electronic mail for requesting electronic file reception, while transmitting electronic mail indicating non-permission for the reception of the electronic file to the electronic mail address of the recipient if the reception of the electronic file is not permitted based on the link information contained in the electronic mail for requesting electronic file reception; and transmitting the electronic file to the recipient terminal connected based on the link information contained in the electronic mail for electronic file delivery if the reception of the electronic file is permitted.

According to the above-described electronic file delivery device and electronic file delivery method of the present invention, the sender who transmits the electronic file connects to the Web page for electronic file transmission through the sender terminal. When the electronic file, the sender information by which the sender can be identified, the electronic mail address of the sender, and the electronic mail address of the recipient receiving the electronic file are acquired from the sender terminal through the Web page for electronic file transmission, the acquired electronic file is stored in the storage means while the electronic mail for notification of electronic file deposit containing the sender information and the link information to the Web page for requesting electronic file reception is transmitted to the electronic mail address of the specified recipient.

The recipient connects to the Web page for requesting electronic file reception by using the recipient terminal based on the link information contained in the electronic mail for notification of electronic file deposit. When the recipient information by which the recipient can be identified is acquired from the recipient terminal by the Web page for requesting electronic file reception to make a request for permission to receive the electronic file to the sender, the electronic mail for requesting electronic file reception containing the acquired recipient information and the link information for permitting or not permitting the recipient to receive the electronic file is transmitted to the electronic mail address of the sender acquired through the Web page for electronic file transmission.

The sender can refer to the recipient information contained in the electronic mail for requesting electronic file reception to confirm again if the transmission was authentically done before the recipient receives the file. If the transmission was authentically done, the reception of the electronic file is permitted based on the link information contained in the electronic mail for requesting electronic file reception. On the other hand, if the transmission was not authentically done or the sender wishes to cancel the delivery, the reception of the electronic file is not permitted based on the link information contained in the electronic mail for requesting electronic file reception.

If the reception of the electronic file is permitted based on the link information contained in the electronic mail for requesting electronic mail reception, the electronic mail for electronic file delivery containing the link information for acquiring the electronic file stored in the storage means is transmitted to the electronic mail address of the recipient. On the other hand, if the reception of the electronic file is not permitted based on the link information contained in the electronic mail for requesting electronic file reception, the electronic mail indicating the non-permission for reception of the electronic file, which does not contain link information for acquiring the electronic file stored in the storage means, is transmitted to the electronic mail address of the recipient.

If the reception of the electronic file is permitted, the electronic file is delivered to the recipient based on the link information contained in the transmitted electronic mail for electronic file delivery. On the other hand, if the reception of the electronic file is not permitted, the electronic mail does not contain any link information for acquiring the electronic file stored in the storage means. Accordingly, the electronic file is never delivered to the recipient. Specifically, it is ensured that the sender can cancel the delivery if required before the recipient receives the file.

The electronic file delivery device and the electronic file delivery method of the present invention may also provide a Web page for electronic file delivery for delivering electronic files stored in the storage means one by one to the recipient terminal in the case where a connection is made from the recipient terminal based on the link information contained in the electronic mail for electronic file delivery. In this case, the Web page for electronic file delivery provided for the recipient terminal indicates the reception of the electronic files stored in the storage means one by one so that the electronic files are transmitted to the recipient terminal by the electronic file transmission means.

The electronic file may be deleted from the storage means if the reception of the electronic file is not permitted. If the reception of the electronic file is not permitted, the unnecessary electronic file is automatically deleted from the storage means so as to enhance the confidentiality of the electronic file of the sender.

Preferably, the Web page for electronic file transmission acquires an ID unique to each transmission of the electronic file from the sender terminal. It is also preferable that the storage means stores the electronic file in association with the ID; the electronic mail for notification of electronic file deposit contains the ID; and the Web page for requesting electronic file reception acquires the ID. Thus, for transmission of a plurality of electronic files, the electronic files stored in the storage means can be managed based on the IDs unique to the respective transmissions.

Preferably, the Web page for electronic file transmission acquires a password in addition to the ID. Furthermore, it is preferable that the electronic file delivery device have means for notifying the sender terminal of a delivery status of the electronic file stored in the storage means in response to a request from the sender terminal based on the ID and the password. Thus, the sender can confirm the delivery status of the electronic file to the specified recipient.

(1) According to the present invention, when the sender delivers various types of electronic files to the recipient specified by the sender, a request for electronic file reception is made to the sender before the recipient receives the electronic file even after the operation of transmission is done. Therefore, the sender can confirm again the transmission and cancel the delivery if necessary. Consequently, erroneous or inadvertent transmission by the sender of the electronic file can be securely cancelled before the delivery to the recipient.

(2) By a structure of providing the Web page for electronic file delivery for delivering the electronic files stored in the storage means one by one to the recipient terminal when the connection is made from the recipient terminal based on the link information contained in the electronic mail for electronic file delivery, the recipient can receive the electronic files by specifying them one by one even if a plurality of electronic files are transmitted from the sender.

(3) By a structure of deleting the electronic file from the storage means in the case where the reception of the electronic file is not permitted, the unnecessary electronic file that is not permitted to receive is automatically deleted from the storage means. Therefore, the confidentiality of the electronic file of the sender can be enhanced.

(4) The Web page for electronic file transmission acquires the ID unique to each transmission of the electronic file from the sender terminal. The storage means stores the electronic file in association with the ID. The electronic mail for notification of electronic file deposit contains the ID. The Web page for requesting electronic file reception acquires the ID. Accordingly, for transmission of a plurality of electronic files, the electronic files stored in the storage means can be managed based on the IDs unique to the respective transmissions. Consequently, a large number of electronic files can be treated.

(5) The Web page for electronic file transmission acquires a password in addition to the ID. Furthermore, by a structure including means for notifying the sender terminal of a delivery status of the electronic file stored in the storage means in response to a request from the sender terminal based on the ID and the password, the sender can confirm the delivery status of the electronic file to the specified recipient.

### BRIEF DESCRIPTION OF THE DRAWINGS

FIG. 1 is a view showing the configuration of an electronic file delivery system according to an embodiment of the present invention;

FIG. 2 is a view showing an example of a Web page for electronic file transmission;

FIG. 3 is a view showing an example of electronic mail for notification of electronic file deposit;

FIG. 4 is a view showing an example of a Web page for requesting electronic file reception;

FIG. 5 is a view showing an example of electronic mail for requesting electronic file reception;

FIG. 6 is a view showing an example of electronic mail for notification of permission/non-permission for electronic file reception in the case where the reception of an electronic file is permitted;

FIG. 7 is a view showing an example of a Web page for electronic file delivery;

FIG. 8 is a view showing an example of electronic mail for delivery status confirmation;

FIG. 9 is a flowchart showing processing by the electronic file delivery system; and

FIG. 10 is a conceptual view of a conventional electronic file delivery system.

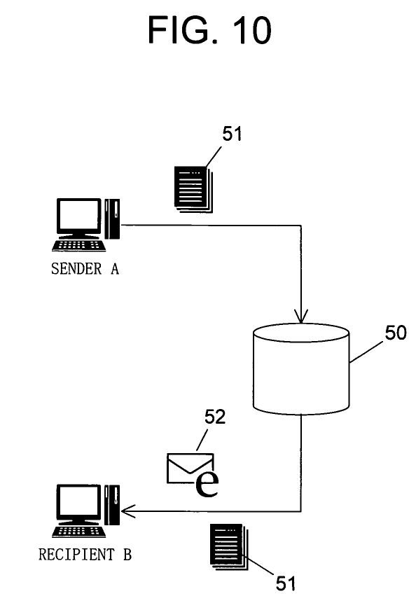

### DETAILED DESCRIPTION OF THE PREFERRED EMBODIMENTS

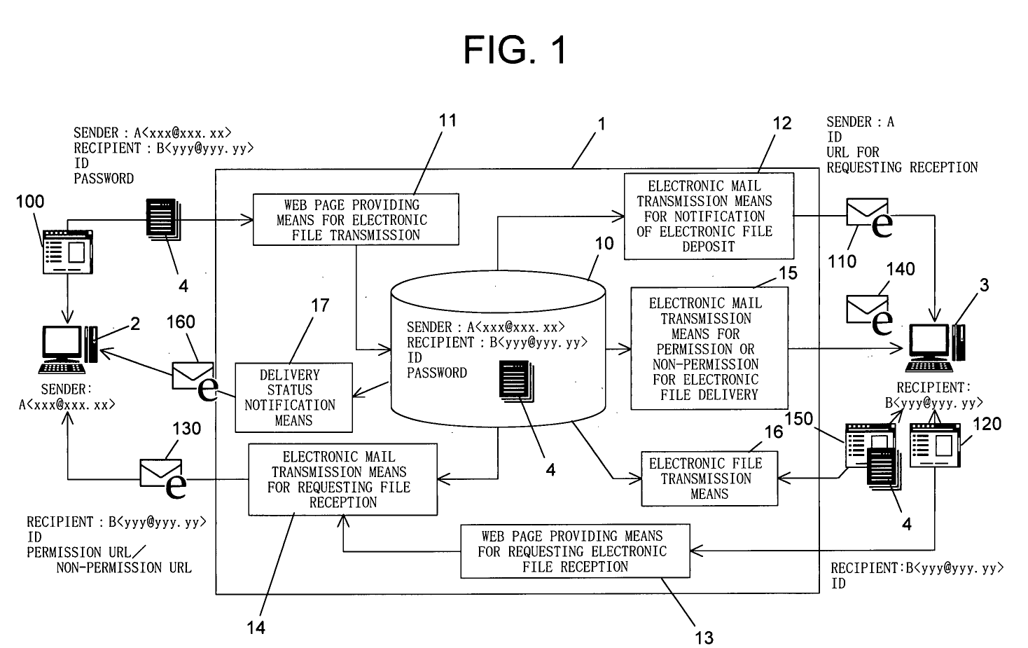

FIG. 1 is a view showing the configuration of an electronic file delivery system according to an embodiment of the present invention.

In FIG. 1, the electronic file delivery system of this embodiment of the present invention includes a computer 2, another computer 3, and an electronic file delivery device (hereinafter, simply referred to as a “delivery device”) 1. The computer 2 acts as a sender terminal used by a sender A who transmits an electronic file 4 (hereinafter, the computer 2 is referred to as a “sender PC” 2). The computer 3 acts as a recipient terminal used by a recipient B who receives the electronic file 4 (hereinafter, the computer 3 is referred to as a “recipient PC” 3). The delivery device 1 transfers the electronic file 4 between the sender PC 2 and the recipient PC 3.

The delivery device 1, the sender PC 2, and the recipient PC 3 are interconnected to each other through a network (not shown). Here, the term “network” means an electrical communication line in a broader sense, including, for example, the Internet, an intranet, a WAN, a LAN, and private lines. In the following description, an example shall be given where the electronic file 4 is transmitted and received between the sender PC 2 of the sender A and the recipient PC 3 of the recipient B. However, the present invention is not limited thereto. There may be more than one of any one or more of sender A, recipient B, sender PC 2, recipient PC 3, and electronic file 4.

Each of the sender PC 2 and the recipient PC 3 can use a Web browser and an electronic mail client, or a web mail. The Web browser is an application program for viewing a Web page (for example, Internet Explorer (trademark) from Microsoft Corporation, Netscape Navigator (trademark) from Netscape Communications Corporation, or the like). The electronic mail client is an application program for transmitting or receiving electronic mail (for example, Outlook Express (trademark) from Microsoft Corporation, Eudora (trademark) from QUALCOMM Incorporated or the like). The Web mail is an electronic mail client available on a Web browser.

The delivery device 1 includes: a storage means 10, a Web page providing means 11 for electronic file transmission, an electronic mail transmission means 12 for notification of electronic file deposit, a Web page providing means 13 for requesting electronic file reception, an electronic mail transmission means 14 for requesting electronic file reception, an electronic mail transmission means 15 for notification of permission or non-permission for electronic file delivery, and an electronic file transmission means 16. The storage means 10 stores various types of information or the like transmitted from the sender PC 2. The Web page providing means 11 for electronic file transmission provides a Web page 100 for electronic file transmission to the sender PC 2. The mail transmission means 12 for notification of electronic file deposit transmits electronic mail 110 for notifying the specified recipient PC 3 that the electronic file 4 has been placed on deposit by the sender PC 2. The Web page providing means 13 for requesting electronic file reception provides a Web page 120 for requesting electronic file reception so that the recipient PC 3 can make a request to the sender PC 2 for permission for the reception of the electronic file 4. The electronic mail transmission means 14 for requesting electronic file reception transmits electronic mail 130 for requesting electronic file reception to the sender PC 2. The electronic mail transmission means 15 for notification of permission or non-permission for electronic file delivery transmits electronic mail 140 notifying whether the sender PC 2 permits the reception of the electronic file 4. The electronic file transmission means 16 transmits the electronic file 4 to the recipient PC 3 if the reception of electronic file 4 is permitted.

The Web page providing means 11 for electronic file transmission provides a Web page for electronic file transmission to the sender PC 2 in order to obtain, from the sender PC 2 used by the sender A who transmits the electronic file 4, the electronic file 4, sender information by which the sender A can be identified, and recipient information by which the recipient B who receives the electronic file 4 can be identified. The sender information includes the name and electronic mail address of the sender A. The recipient information includes the name and electronic address of the recipient B.

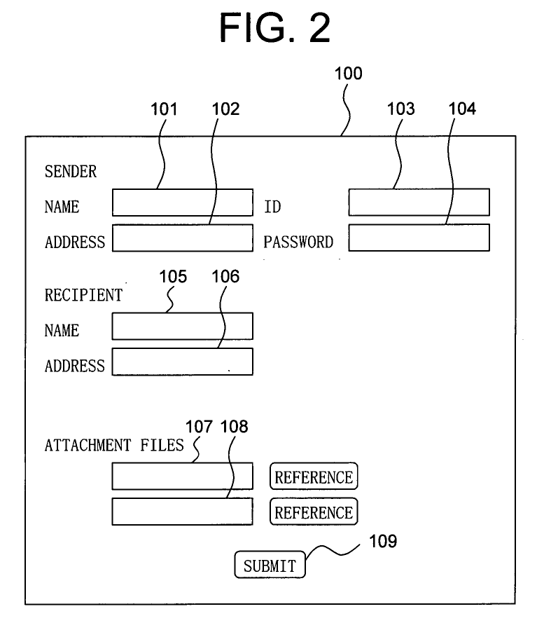

FIG. 2 shows an example of the Web page 100 for electronic file transmission. The Web page 100 for electronic file transmission shown in FIG. 2 has fields 101 to 104 for entry of a name, an electronic mail address, an ID, and a password of the sender A, respectively; fields 105 and 106 for entry of a name and an electronic mail address of the recipient B, respectively; fields 107 and 108 for specifying the electronic file (attachment file) 4 to be transmitted; and a submit button 109. As for the ID, an ID unique to each transmission of the electronic file 4 is automatically assigned and is managed by the storage means 10. The ID managed by the storage means 10 is automatically entered into the entry field 103 for the ID. When the entry for each of the fields 101 to 108 is completed and the submit button 109 is pressed by the sender PC 2, the information entered into each of the fields 101 to 108 is transmitted from the sender PC 2 to the delivery device 1 so that the information is stored in the storage means 10 in association with the ID.

The electronic mail transmission means 12 for notification of electronic file deposit transmits the electronic mail 110 for notification of electronic file deposit. This mail 110, which includes the name and the ID of the sender A and a URL (Uniform Resource Locator) as link information to the Web page 120 for requesting electronic file reception, is sent to the electronic mail address of the recipient B. The electronic mail 110 for notification of electronic file deposit is transmitted when the above-mentioned information is stored in the storage means 10, or at a specified point of time.

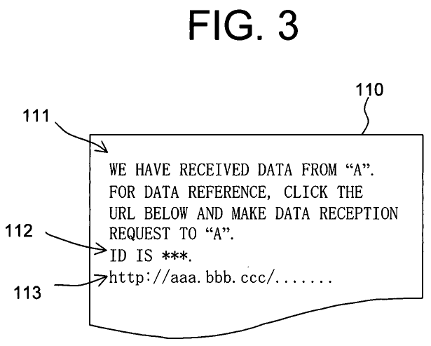

FIG. 3 shows an example of the electronic mail 110 for notification of electronic file deposit. As shown in FIG. 3, the electronic mail 110 for notification of electronic file deposit contains a notice of the deposit of the electronic file 4 by the sender A, a notice of the need for making a request to the sender A for permission to receive the electronic file 4, the name 111 and ID 112 of the sender A, and a URL 113 to the Web page 120 for requesting electronic file reception.

The Web page providing means 13 for requesting electronic file reception provides the Web page 120 for requesting electronic file reception for allowing the recipient PC 3 to make a request to the sender PC 2 for permission to receive the electronic file 4. After the recipient B receives the electronic mail 110 for notification of electronic file deposit by means of the electronic mail client of the receiver PC 3, the recipient B uses the URL 113 contained in the electronic mail 110 on the electronic mail client or Web browser to connect to the delivery device 1. Thus, the recipient B can obtain the Web page 120 for requesting electronic file reception.

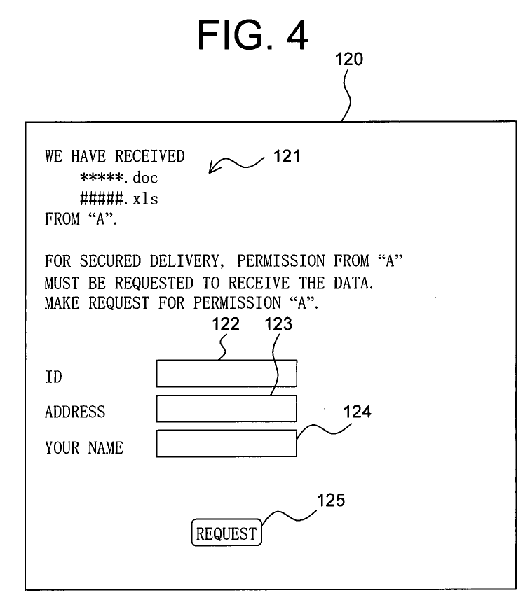

FIG. 4 shows an example of a Web page 120 for requesting electronic file reception. As shown in FIG. 4, the Web page 120 for requesting electronic file reception shows thereon a notice of the deposit of the electronic file 4 by the sender A, a notice of the need for making a request to the sender A for permission to receive the electronic file 4, and the name 121 of the electronic file 4 placed on deposit by the sender A. In addition, the Web page 120 for requesting electronic file reception contains fields 122 to 124 for entry of the ID and the electronic mail address, and the name of the recipient B, respectively, as well as a request button 125. When the entry into each of the fields 122 to 124 is completed and the request button 125 is pressed by the recipient PC 3, the information entered into each of the fields 122 to 124 is transmitted from the recipient PC 3 to the delivery device 1.

The electronic mail transmission means 14 for requesting electronic file reception transmits the electronic mail 130 for requesting electronic file reception to the electronic mail address of the sender A based on each of the information transmitted and acquired from the recipient PC 3 to the delivery device 1 through the Web page 120 for requesting electronic file reception. The electronic mail 130 for requesting electronic file reception is transmitted when or after the information reaches the delivery device 1 from the recipient PC 3 through the Web page 120 for requesting electronic file reception.

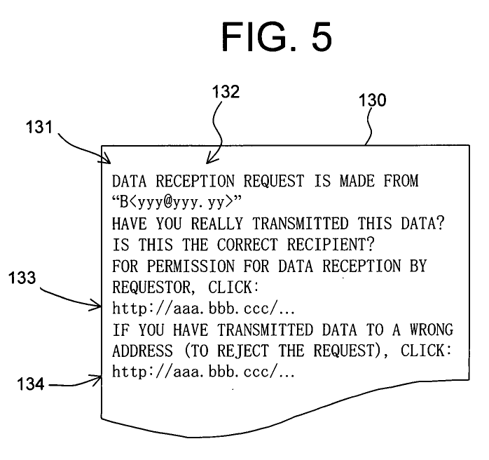

FIG. 5 shows an example of the electronic mail 130 for requesting electronic file reception. As shown in FIG. 5, the electronic mail 130 for requesting electronic file reception contains the name 131 and electronic mail address 132 of the recipient B, a URL 133 as link information for permitting the recipient B to receive the electronic file 4, and a URL 134 for not permitting (rejecting) the recipient B to receive the electronic file 4. The URLs 133 and 134 are associated with the ID by the electronic mail transmission means 14 for requesting electronic file reception. The sender A receives the electronic mail 130 for requesting electronic file reception by means of the electronic mail client of the sender PC 2 and uses the URL 133 or 134 contained therein on the electronic mail client or the Web browser to connect to the delivery device 1. Thus, the sender A can specify permission or non-permission to receive the electronic file 4.

When the sender PC 2 has permitted or has not permitted the reception of the electronic file 4, electronic mail transmission means 15 for notification of permission or non-permission for electronic file delivery transmits electronic mail 140 notifying the permission or non-permission, accordingly. The electronic mail 140 is transmitted when or after the permission or non-permission for reception of the electronic file 4 is specified by the sender PC 2 as described above.

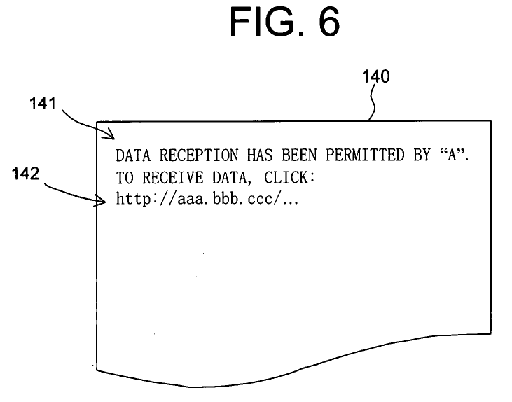

FIG. 6 shows an example of the electronic mail 140 in the case where the reception of the electronic file 4 has been permitted. As shown in FIG. 6, if the reception of the electronic file 4 is permitted, the electronic mail 140 contains the name 141 of the sender A, a notice of the permission for reception of the electronic file 4 by the sender A, and a URL 142 as link information to a Web page 150 for electronic file delivery to receive the electronic file 4.

If the connection is made by the recipient PC 3 based on the URL 142, the electronic file transmission means 16 provides the Web page 150 for electronic file delivery to deliver the electronic file 4 stored in the storage means 10 to the recipient PC 3 so as to transmit the electronic file 4 to the recipient PC 3.

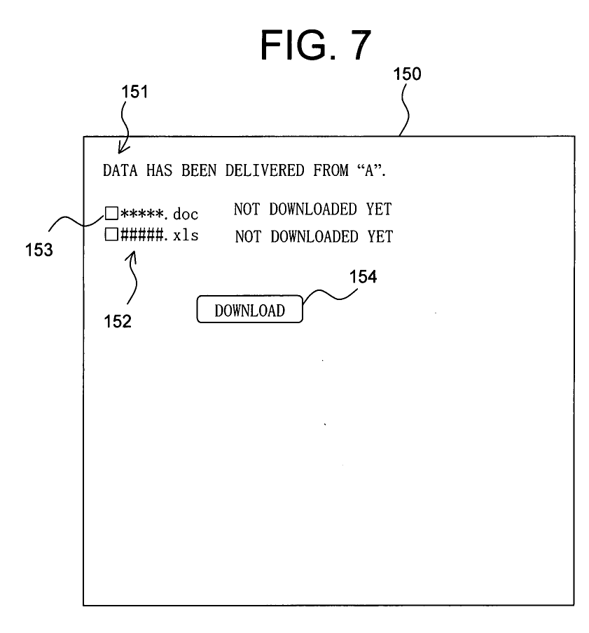

FIG. 7 shows an example of the Web page 150 for electronic file delivery. As shown in FIG. 7, the Web page 150 for electronic file delivery shows thereon the name 151 of the sender A, a notice of the delivery of the electronic file 4 from the sender A, a list 152 of the electronic files 4 stored in the storage means 10, and an indication of a reception status of each of the electronic files 4. The list 152 of the electronic files 4 stored in the storage means 10 is created based on the ID associated with the URL 133 described above. On the Web page 150 for electronic file delivery, a check box 153 and a download button 154 are also provided. The check box 153 is used to allow the user to specify the electronic files 4 stored in the storage means 10 and listed on the list 152 one by one to receive them.

The recipient B can specify which electronic files 4 are to be received by ticking the check box 153 on the Web page 150 for electronic file delivery. When the check box 153 is ticked and the download button 154 is pressed by the recipient PC 3, the electronic file transmission means 16 acquires the corresponding electronic file 4 from the storage means 10 and then transmits it to the recipient PC 3. Thus, the electronic file 4 is downloaded (received) by the recipient PC 3.

The electronic file transmission means 16 may also have such a structure that the electronic file 4 is directly transmitted to the recipient PC 3 other than through the Web page 150 for electronic file delivery as in the case described above. In such a case, the electronic mail 140 contains a URL as link information to the electronic file 4 in the storage means 10 instead of the URL 113 as link information to the Web page 150 for electronic file delivery to receive the electronic file 4.

On the other hand, if the reception of the electronic file 4 is not permitted (rejected), the electronic mail 140 contains a description indicating that the reception of the electronic file 4 has not been permitted (rejected) by the sender A and does not contain any link information to receive the electronic file 4 (though not shown). Therefore, the recipient B cannot receive the electronic file 4. If the reception of the electronic file 4 is not permitted, the electronic file 4 may be deleted from the storage means 10.

Returning to FIG. 1, the delivery device 1 may also include a delivery status notification means 17 for notifying the sender PC 2 of delivery status of the electronic file 4 stored in the storage means 10. The delivery status notification means 17 notifies the sender PC 2 of the delivery status of the electronic file 4 by electronic mail 160 after the processing by the Web page providing means 11 for electronic file transmission, the electronic mail transmission means 12 for notification of electronic file deposit, the electronic mail transmission means 15 for notification of permission or non-permission for electronic file delivery, or the electronic file transmission means 16.

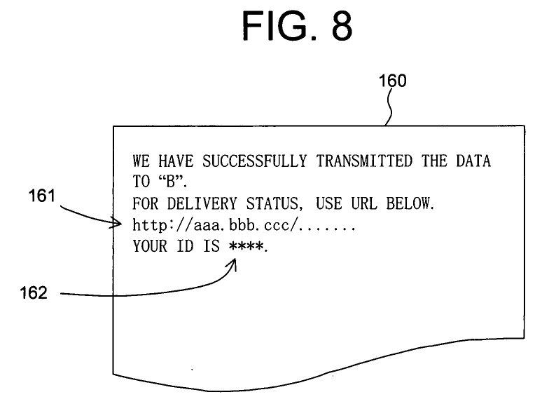

FIG. 8 shows an example of the electronic mail 160 for delivery status confirmation, which is transmitted to the sender PC 2. The electronic mail 160 for delivery status confirmation shown in FIG. 8 contains a URL 161 as link information to a Web page for confirmation of delivery status and an ID 162. The sender A uses the URL 161 contained in the electronic mail 160 for delivery status confirmation to connect to the delivery device 1 so as to make a request for the delivery status of the electronic file 4 based on the ID and the password used at the transmission of the electronic file 4. In response to the request, the delivery status notification means 17 notifies the sender PC 2 of the delivery status of the electronic file 4 stored in the storage means 10 through a Web page (not shown). Instead of being shown on the Web page, the delivery status of the electronic file 4 can also be directly contained in the electronic mail 160 for delivery status confirmation.

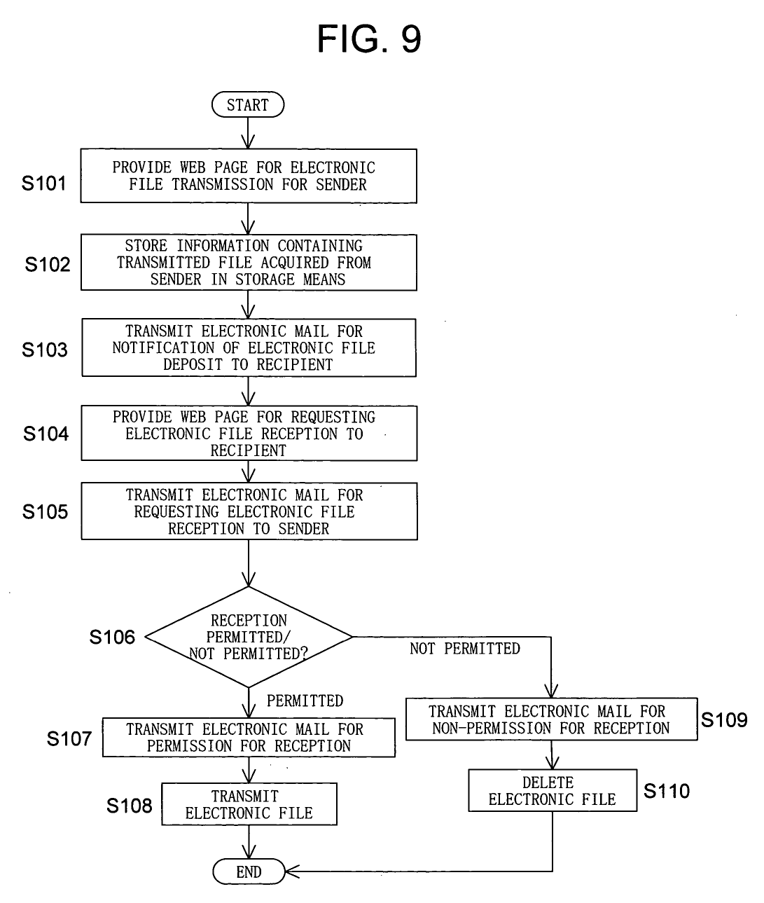

Hereinafter, the processing by the electronic file delivery system having the above structure will be described in accordance with the flowchart shown in FIG. 9.

The delivery device 1 provides the Web page 100 for electronic file transmission shown in FIG. 2 by the Web page providing means 11 for electronic file transmission based on a request from the sender PC 2 of the sender A (step SI 01). The delivery device 1 acquires information including the electronic file 4 which is inputted and transmitted on the Web page 100 for electronic file transmission by the sender PC 2 and stores it in the storage means 10 (step S102).

The delivery device 1 transmits the electronic mail 110 for notification of electronic file deposit shown in FIG. 3 to the electronic mail address of the recipient B by means of the electronic mail transmission means 12 for notification of electronic file deposit (step S103). The delivery device 1 provides the Web page 120 for requesting electronic file reception shown in FIG. 4 by means of the Web page providing means 13 for requesting electronic file reception based on a request by the recipient PC 3 using the URL 113 contained in the electronic mail 110 for notification of electronic file deposit, which is addressed to the recipient B (step S104).

The delivery device 1 acquires the information entered and transmitted by the recipient PC 3 on the Web page 120 for requesting electronic file reception. Then, the electronic mail 130 for requesting electronic file reception shown in FIG. 5 is created by the electronic mail transmission means 14 for requesting electronic file reception, and is transmitted to the electronic mail address of the sender A (step S105).

If the reception of the electronic file 4 is permitted by the URL 133 for permitting electronic file reception contained in the electronic mail 130 for requesting electronic file reception, the delivery device 1 transmits the electronic mail 140 for electronic file delivery for permission for reception shown in FIG. 6 to the electronic mail address of the recipient B by means of the electronic mail transmission means 15 for notification of permission or non-permission for electronic file delivery (steps S106 and S107). When the recipient PC 3 connects to the delivery device 1 based on the URL 142 contained in the electronic mail 140 for electronic file delivery, the delivery device 1 transmits the electronic file 4 to the recipient PC 3 by means of the electronic file transmission means 16 (step S108). Thus, the electronic file 4 is received by the recipient PC 3.

On the other hand, if the reception of the electronic file 4 is not permitted through the URL 134 for not permitting the reception of the electronic file, which is contained in the electronic mail 130 for requesting electronic file reception, the electronic mail 140 indicating the non-permission for reception is transmitted to the electronic mail address of the recipient B by means of the electronic mail transmission means 15 for notification of permission or non-permission for electronic file delivery (steps S106 to S109). Then, the delivery device 1 deletes the electronic file 4 stored in the storage means 10 as required (step S110).

As described above, according to the electronic file delivery system in this embodiment, when delivering various types of electronic files 4 to the recipient B specified by the sender A, a request for reception of the electronic file 4 is made to the sender A before the recipient B receives the electronic file 4 even after the operation of transmission is done. Therefore, the sender A can confirm the transmission again and delete the delivery of the electronic file if necessary. Consequently, it is ensured that erroneous transmission or unintended transmission by the sender A of the electronic file 4 is cancelled before the electronic file 4 is delivered to the recipient B.

Moreover, the recipient B can specify the electronic files 4 stored in the storage means 10 one by one by ticking the check box 153 on the Web page 150 for electronic file delivery to receive them on the recipient PC 3. Accordingly, even if a plurality of electronic files 4 are transmitted from the sender A, the recipient B can specify and receive the electronic files 4 one by one.

Furthermore, in the electronic file delivery system of this embodiment, in the case where the reception of the electronic file 4 is not permitted (rejected), the electronic file 4 is deleted from the storage means 10. Therefore, the unnecessary electronic file 4, which is not permitted to be received, is automatically deleted from the storage means 10, and thus the confidentiality of the electronic file 4 of the sender can be improved.

In addition, in the electronic file delivery system of this embodiment, the electronic file 4 stored in the storage means 10 is managed by its specific ID. Therefore, for transmissions made by a plurality of senders A or a plurality of transmissions by the same sender A, each of the transmissions can be treated based on its own specific ID. Accordingly, a large number of electronic files can be handled by the electronic file delivery system of this embodiment.

The electronic file delivery device and delivery method of the present invention are useful as a device and a method for delivering various types of electronic files to a recipient specified by a sender. In particular, the file delivery device and delivery method of the present invention are suitable for securely delivering a large-volume file.

While there has been described what is at present considered to be a preferred embodiment of the invention, it will be understood that various modifications may be made thereto, and it is intended that the appended claims cover all such modifications as fall within the true spirit and scope of the invention.

What is claimed is:

1. An electronic file delivery device comprising:
means for providing a Web page for electronic file transmission for acquiring, from a sender terminal used by a sender transmitting an electronic file, the electronic file, sender information by which the sender can be identified, an electronic mail address of the sender, and an electronic mail address of a recipient receiving the electronic file;
storage means for storing the electronic file acquired through the Web page for electronic file transmission;
means for providing a Web page for requesting electronic file reception for acquiring, from a recipient terminal used by the recipient receiving the electronic file, recipient information by which the recipient can be identified to make a request for permission to receive the electronic file to the sender;
means for transmitting electronic mail for notification of electronic file deposit to the electronic mail address of the recipient acquired through the Web page for electronic file transmission, said electronic mail for notification of electronic file deposit containing the sender information acquired through the Web page for electronic file transmission and link information to the Web page for requesting electronic file reception;
means for transmitting electronic mail for requesting electronic file reception to the electronic mail address of the sender acquired through the Web page for electronic file transmission, said electronic mail for requesting electronic file reception containing the recipient information acquired through the Web page for requesting electronic file reception and link information for permitting or not permitting the recipient to receive the electronic file;
means for transmitting electronic mail for electronic file delivery containing link information for acquiring the electronic file stored in the storage means to the electronic mail address of the recipient acquired through the Web page for electronic file transmission if the reception of the electronic file is permitted based on the link information contained in the electronic mail for requesting electronic file reception, while transmitting electronic mail indicating non-permission for the reception of the electronic file to the electronic mail address of the recipient if the reception of the electronic file is not permitted based on the link information contained in the electronic mail for requesting electronic file reception; and
means for transmitting the electronic file to the recipient terminal connected based on the link information contained in the electronic mail for electronic file delivery.

2. The electronic file delivery device according to claim 1, comprising means for providing a Web page for electronic file delivery for delivering electronic files stored in the storage means one by one to the recipient terminal in the case where a connection is made from the recipient terminal based on the link information contained in the electronic mail for electronic file delivery.

3. The electronic file delivery device according to claim 1, comprising means for deleting the electronic file from the storage means if the reception of the electronic file is not permitted.

4. The electronic file delivery device according to claim 2, comprising means for deleting the electronic file from the storage means if the reception of the electronic file is not permitted.

5. The electronic file delivery device according to claim 1, wherein:
the Web page for electronic file transmission acquires an ID unique to each transmission of the electronic file from the sender terminal;
the storage means stores the electronic file in association with the ID;
the electronic mail for notification of electronic file deposit contains the ID; and
the Web page for requesting electronic file reception acquires the ID.

6. The electronic file delivery device according to claim 2, wherein:
the Web page for electronic file transmission acquires an ID unique to each transmission of the electronic file from the sender terminal;
the storage means stores the electronic file in association with the ID;
the electronic mail for notification of electronic file deposit contains the ID; and
the Web page for requesting electronic file reception acquires the ID.

7. The electronic file delivery device according to claim 3, wherein:
the Web page for electronic file transmission acquires an ID unique to each transmission of the electronic file from the sender terminal;
the storage means stores the electronic file in association with the ID;
the electronic mail for notification of electronic file deposit contains the ID; and
the Web page for requesting electronic file reception acquires the ID.

8. The electronic file delivery device according to claim 4, wherein:
the Web page for electronic file transmission acquires an ID unique to each transmission of the electronic file from the sender terminal;
the storage means stores the electronic file in association with the ID;
the electronic mail for notification of electronic file deposit contains the ID; and
the Web page for requesting electronic file reception acquires the ID.

9. The electronic file delivery device according to claim 1, wherein:
the Web page for electronic file transmission acquires a password in addition to the ID; and
the device comprises means for notifying the sender terminal of a delivery status of the electronic file stored in the storage means in response to a request from the sender terminal based on the ID and the password.

10. The electronic file delivery device according to claim 2, wherein:
the Web page for electronic file transmission acquires a password in addition to the ID; and
the device comprises means for notifying the sender terminal of a delivery status of the electronic file stored in the storage means in response to a request from the sender terminal based on the ID and the password.

11. The electronic file delivery device according to claim 3, wherein:
the Web page for electronic file transmission acquires a password in addition to the ID; and
the device comprises means for notifying the sender terminal of a delivery status of the electronic file stored in the storage means in response to a request from the sender terminal based on the ID and the password.

12. The electronic file delivery device according to claim 4, wherein:
the Web page for electronic file transmission acquires a password in addition to the ID; and
the device comprises means for notifying the sender terminal of a delivery status of the electronic file stored in the storage means in response to a request from the sender terminal based on the ID and the password.

13. The electronic file delivery device according to claim 5, wherein:
the Web page for electronic file transmission acquires a password in addition to the ID; and
the device comprises means for notifying the sender terminal of a delivery status of the electronic file stored in the storage means in response to a request from the sender terminal based on the ID and the password.

14. The electronic file delivery device according to claim 6, wherein:
the Web page for electronic file transmission acquires a password in addition to the ID; and
the device comprises means for notifying the sender terminal of a delivery status of the electronic file stored in the storage means in response to a request from the sender terminal based on the ID and the password.

15. The electronic file delivery device according to claim 7, wherein:
the Web page for electronic file transmission acquires a password in addition to the ID; and
the device comprises means for notifying the sender terminal of a delivery status of the electronic file stored in the storage means in response to a request from the sender terminal based on the ID and the password.

16. The electronic file delivery device according to claim 8, wherein:
the Web page for electronic file transmission acquires a password in addition to the ID; and
the device comprises means for notifying the sender terminal of a delivery status of the electronic file stored in the storage means in response to a request from the sender terminal based on the ID and the password.

17. An electronic file delivery method comprising the steps of:
providing a Web page for electronic file transmission for acquiring, from a sender terminal used by a sender transmitting an electronic file, the electronic file, sender information by which the sender can be identified, an electronic mail address of the sender, and an electronic mail address of a recipient receiving the electronic file;
storing the electronic file acquired through the Web page for electronic file transmission in storage means;
transmitting electronic mail for notification of electronic mail deposit to the electronic mail address of the recipient acquired through the Web page for electronic file transmission, said electronic mail for notification of electronic mail deposit containing the sender information acquired through the Web page for electronic file transmission and link information to a Web page for requesting electronic file reception for acquiring recipient information by which the recipient can be identified to make a request for permission to receive the electronic file to the sender from a recipient terminal used by the recipient receiving the electronic file;
providing the Web page for requesting electronic file reception to the recipient terminal connected based on the link information contained in the electronic mail for notification of electronic file deposit;
transmitting electronic mail for requesting electronic file reception to the electronic mail address of the sender acquired through the Web page for electronic file transmission, said electronic mail for requesting electronic file reception containing the recipient information acquired through the Web page for requesting electronic file reception and link information for permitting or not permitting the recipient to receive the electronic file;
transmitting electronic mail for electronic file delivery containing link information for acquiring the electronic file stored in the storage means, to the electronic mail address of the recipient acquired through the Web page for electronic file transmission if the reception of the electronic file is permitted based on the link information contained in the electronic mail for requesting electronic file reception, while transmitting electronic mail indicating non-permission for the reception of the electronic file to the electronic mail address of the recipient if the reception of the electronic file is not permitted based on the link information contained in the electronic mail for requesting electronic file reception; and
transmitting the electronic file to the recipient terminal connected based on the link information contained in the electronic mail for electronic file delivery if the reception of the electronic file is permitted.
